(19) United States
(12) Patent Application Publication
(10) Pub. No.: US 2021/0204517 A1
(43) Pub. Date: Jul. 8, 2021

(54) SEE-THROUGH PET TOY WITH REMOVABLE SECONDARY TOY

(71) Applicants: Elizabeth Bentz, Denver, CO (US); Graham Wilson, Denver, CO (US)

(72) Inventors: Elizabeth Bentz, Denver, CO (US); Graham Wilson, Denver, CO (US)

(21) Appl. No.: 16/737,436

(22) Filed: Jan. 8, 2020

(51) Int. Cl. A01K 15/02

(52) U.S. Cl. CPC A01K 15/026

(57) ABSTRACT

The invention is an animal shaped toy with a transparent front side that exposes a second internal free-floating squeaking toy that a pet can pursue after chewing the external toy apart. The internal squeaker toy can have scents such as chicken or bacon to match the shape of the internal squeaking toy.

### FIELD

The present invention relates generally to stimulating, encouraging and motivating games and methods of playing regarding pets, e.g. dogs and cats. More particularly, the invention relates to motivational games, toys and methods for assessing the pet training skills in the form of games or puzzles that incite pet interaction and memory skills.

### PRIOR ART

There are many types of pet toys on the market that squeak or that can be used in a tug-of-war game between an owner and a dog, or multiple dogs without their owner's interaction. This novel toy is designed to have a transparent front side body section wherein a scented edible treat can be seen and smelled by a dog and in which it has to devise a way to obtain the treat.

### BRIEF DESCRIPTION OF THE INVENTION

The novel design of the inventive toy satisfies a dog's instinct to tug and tear at a toy that makes noise in response. Studies have shown that even the most domesticated dog retains an ancestral instinct to actually kill its prey. Enter toys designed to make sounds in response to the dog's “attack”.

The object of the present invention is to motivate and maintain interest of a pet, and also be a durable toy that continues to function after being aggressively used by a pet. Pet owners spend several billion dollars per year on pet toys, and this toy provides great value for the price because the squeak toy inside can be used if the pet chews through the first layer of the toy.

Veterinarians caution pet owners about using the right kind of toy especially when the pet will be left alone for time periods. The toy should be durable, and not contain small pieces easily swallowed, but not so easily expelled. The inventive toy meets that criteria as well as providing the audible stimuli that will keep a dog interested in the toy, and hopefully not so interested in the couch.

### BACKGROUND OF THE INVENTION

The invention most closely corresponds with USPTO Class 119/707 wherein Class 119 relates to animal husbandry and sub-class 707 includes toys.

In its simplest form, the invention relates to a novel toy for pets wherein a two-piece toy has an external shell with a transparent front and another toy sewn into the outer shell for a pet to play with if it chews the outer shell open. The back side of the toy may be a plush fabric with polyfill stuffing inserted between the front and back sides connected by turn seam construction.

### THE INVENTION

### Summary, Objects and Advantages

It well known that pets do experience a sense of boredom, and if not addressed, may manifest in negative behavior such as chewing furniture or going to the bathroom in undesirable locations in the pet owner's home. When presented with a toy that makes a high-pitched squeaky noise, many dogs will revert to a stylized version of the shake and kill pattern of their wild ancestors. This prey-cry trigger can cause dogs to rip apart their toys in an effort to get to the sound and “kill” the squeak. Our positive attention encourages our dogs to continue pulling apart toys until it's a hard habit to break. The inventive toy provides a secondary option when the toy inside the shell is acquired and the pet can chew the second toy which will also squeak in response to chewing. The type of animal character is not limited to the embodiments herein, but would be appreciated to be any animal provided the transparent front side with internal treat configuration is used.

### BRIEF DESCRIPTION OF THE DRAWINGS

The invention is described in further detail by reference to six (6) drawings sufficient in detail to describe the invention in which:

FIG. 1 is an embodiment of a chicken shape showing the internal toy and other features;

FIG. 2 is an embodiment of a pig shape showing the internal toy and other features;

FIG. 3 is an embodiment of a donkey showing the internal toy and other features;

FIG. 4 is an example of the pig embodiment with the internal squeaker toy and dashed lines depicting the transparent front section;

FIG. 5 is an illustration of facial features as may be printed on the toy; and

FIG. 6 is a side perspective to illustrate relative thickness of the toy.

### DETAILED DESCRIPTION, INCLUDING BEST MODES OF CARRYING OUT THE INVENTION

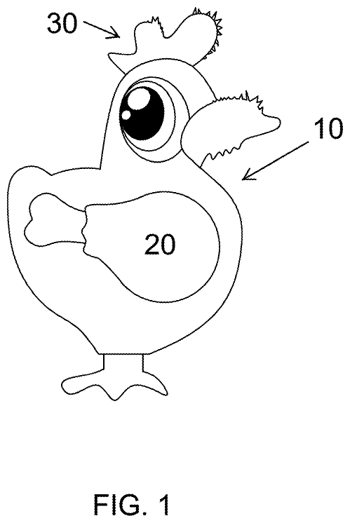

FIG. 1 shows an embodiment of the chicken shaped toy body 10. Within this toy is a chicken leg squeaker toy 20. Felt or fabric features 30 provide related parts such as beaks, feet or feathers.

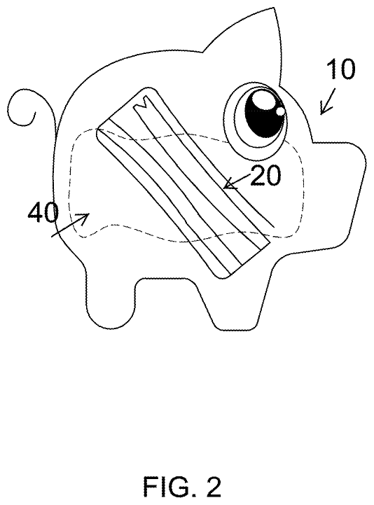

FIG. 2 shows a pig embodiment again with a general body 10. The internal toy 20 in this embodiment resembles a piece of bacon and contains a squeaker within its malleable shell that will respond to a pet compressing the internal toy. Shown in dashed lines 40 depicts a transparent front section wherein the internal squeaking toy is visible to a pet. This internal toy may also contain a scent similar to that of actual bacon to further entice a pet to chew the toy.

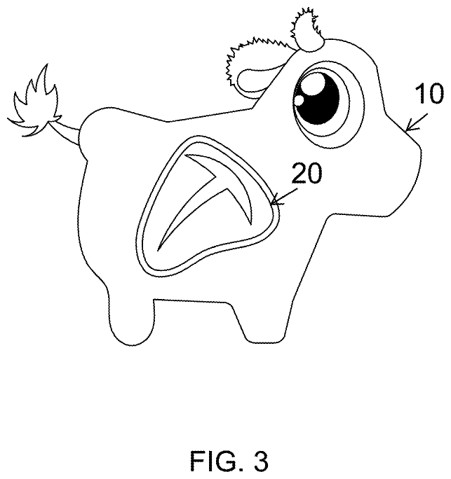

FIG. 3 is an embodiment of a cow character body 10. In this embodiment, the internal squeaking toy resembles a steak 20. The key element being the toy has a transparent front piece so that internal squeaking toys may be seen or smelled by a pet. As is typical with stronger animals, the toy may be chewed apart. The novel toy here provides a second durable internal toy so that a pet has something else to utilize when and if it chews the external body apart. The latter being very common especially with larger dogs.

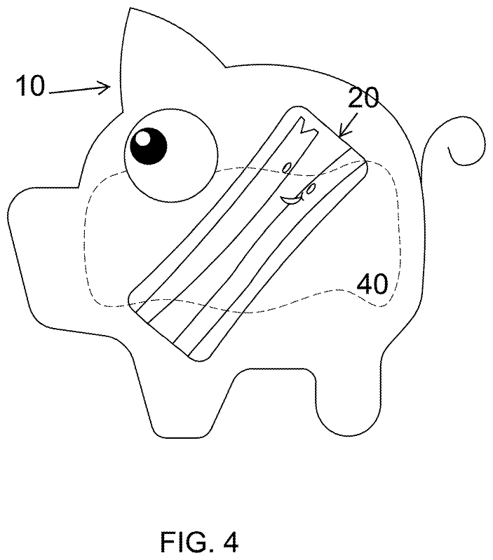

FIG. 4 is the pig embodiment with a general body 10 and an internal sqwweuker toy 20. Of key note is the transparent front section of the toy 40 which contains the second squeaker chew toy in case the pet chews the toy apart in total. The transparent section may be a window of transparent material or most of the front piece of the toy. It is apparent that the size of the “window” is not crucial to the effect.

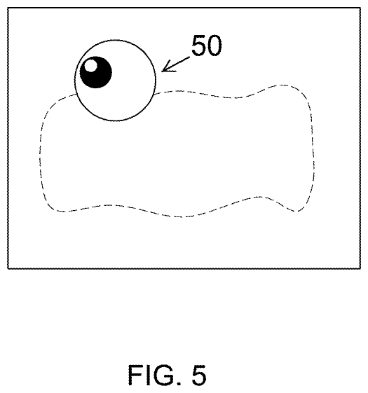

FIG. 5 illustrates facial features 50 which may be printed on the external front piece of the toy to add to discerning the toy's character whether the pig, cow or chicken as examples.

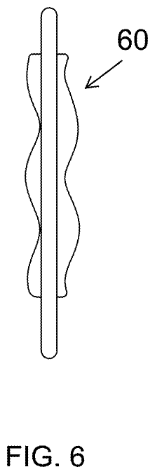

FIG. 6 is a side perspective of the toy to illustrate that the surfaces will not be flat 60 as they will contain the front and back pieces of the toy body and show the topography of the toy as contains the internal squeaking pieces and internal poly stuffing.

1) A pet toy comprising:
a) A two-piece plush and poly animal shaped toy with head and facial features and limbs;
b) A first front side which is transparent;
c) A first back side of plush fabric with turn seam construction attached it to the first front side;
d) An internal squeaking toy which is free-floating within the first front and back sides of the toy;
e) Felt appendages such as ears, horns or other characteristics of the animal character embodied in the toy.

2) A pet toy as in claim 1 wherein a first front side is a transparent poly material which allows viewing of an internal squeaking toy.

3) A pet toy as in claim 1 wherein the first back side of the toy is a plush fabric with poly fill to create topography and pliability on the toy and wherein the back side is sewn to the first front side using a turn seam construction around the entire perimeter edges of the two sides to affix them to one another.

4) A pet toy as in claim 1 wherein an internal toy is free-floating within the first front and back pieces of the toy and wherein the internal toy contains a squeaker and serves as a secondary toy when a pet may chew the first front and back sides of the toy apart allowing release of the internal toy.

6) A pet toy as in claim 1 wherein the internal squeaking toy may also have a scent such as chicken or beef to entice a pet to pursue the internal toy once the first front and back sides may be chewed apart by the pet.

7) A pet toy as in claim 1 wherein felt appendages particular to a toy character are sewn into the first front and back sides using a turn seam construction method and may be comprised of ears, horns, tails or other common appendages specific to a toy animal shape.
